(19) United States
(12) Patent Application Publication
(10) Pub. No.: US 2005/0027993 A1
(43) Pub. Date: Feb. 3, 2005

(54) Transmitting device, receiving device and transmitting/receiving system

(75) Inventor: Ryogo Yanagisawa, Osaka (JP)

Correspondence Address: Jack Q. Lever, Jr.;McDERMOTT, WILL & EMERY, 600 13th Street, N.W., Washington, DC, 20005-3096, US

(73) Assignee: MATSUSHITA ELECTRIC INDUSTRIAL CO., LTD.

(21) Appl. No.: 10/852,123

(22) Filed: May 25, 2004

(30) Foreign Application Priority Data
Jul. 29, 2003 (JP) 2003-282170

(51) Int. Cl. H04L 9/00

(52) U.S. Cl. 713/189

(57) ABSTRACT

A transmitting device includes a transmission side control data memory. A receiving device includes a receiving side control data memory. In an operation state, EDID, a device key for and HDCP and the like are stored in the receiving side control data memory. Subsequently, the EDID and information necessary for HDCP authentication are copied from the receiving side control data memory to the transmission side control data memory through the DDC. A transmission controller accesses the transmission side control data memory and executes plug-and-play and HDCP authentication. The DDC realizes a one-to-one connection between the transmitting device and the receiving device. Thus, waveform distortion can be minimized and the length of a cable can be increased in a simple manner.

### CROSS-REFERENCE TO RELATED APPLICATION

This application claims priority under 35 U.S.C. §119(a) on Japanese Patent Application No. 2003-282170, the entire contents of which are hereby incorporated by reference.

### BACKGROUND OF THE INVENTION

1. Filed of the Invention

The present invention relates to a transmitting device, a receiving device and a transmitting/receiving system which are used for performing high-speed transmission of a video signal.

2. Description of the Prior Art

Conventionally, a DVI (Digital Visual Interface) standard has been known as an interface for transmitting a digitalized video signal at high speed between a system unit of a computer and a display (e.g., see Japanese Laid-Open Publication No. 2002-314970).

Moreover, as an unauthorized copy protection system of DVI, HDCP (High-bandwidth Digital Content Protection) has been known (see Japanese Laid-Open Publication No. 2002-314970). A known transmitting/receiving system using HDCP will be hereafter described.

FIG. 4 is a block diagram illustrating an example for a known transmitting/receiving system. The known transmitting/receiving system for a video signal shown in FIG. 4 includes a transmitting device 143 and a receiving device 148.

The transmitting device 143 of the transmitting/receiving system is part of a transmission side processing device 201 for reading out video data recorded on a recording medium and transmitting the video data as a digital video signal. Moreover, the receiving device 148 is part of a display device 203 for displaying the digital video signal received from the transmission side processing device 201 and is often provided as a single unit of an LSI.

The transmission side processing device 201 and a display device 203 in the known system are connected to each other through a transmission line 160 based on the DVI standard. Personal computers and DVD players are examples of the transmission side processing device 201, and TV sets, liquid crystal display devices are examples of the display device 203.

As shown in FIG. 4, the transmission side processing device 201 includes a first memory for holding a first device key 117, a transmission controller 142, a transmission data processor 116 for performing data processing of a video signal recorded on a recording medium, and the transmitting device 143 which is connected to each of the transmission controller 142 and the transmission data processor 116, encrypts a video signal and transmits the encrypted video signal.

The transmitting device 143 is connected to the transmission controller 142 and includes an encryption controller 141 for encrypting a video signal, a data encrypter 112 connected to the transmission data processor 116, and a data transmitter 111 which is connected to the data encrypter 112 and outputs an encrypted video signal to the display device 203 through a high-speed bus 161 of the transmission line 160.

On the other hand, the display device 203 includes a receiving device 148 for receiving an encrypted video signal and de-encrypting the video signal, a second memory for holding a second device key 146, a receiving controller 145 connected to a third memory for holding receiving side information 147, a received data processor 126 for performing data processing of a video signal de-encrypted by the receiving device 148, and a panel 128 for displaying a video data processed by the received data processor 126. The third memory is connected to the transmission controller 142 through a low-speed bus 162 of the transmission line 160. Moreover, the receiving side information 147 includes EDID (Extended Display Identification Data). Specifically, when the present DVI or HDMI (High-definition Multimedia Interface) standard is used, the receiving side information 147 is the same as the EDID. The EDID includes information for kinds of signals which the display device 203 can process, information for the resolution of the panel and the like, information for pixel clock, information for a horizontal effective period and a vertical effective period, or like information.

The receiving device 148 includes a data receiver 121 for receiving an encrypted video signal through the high-speed bus 161, a de-encryption controller 144, and a data de-encrypter 122 connected to the data receiver 121 and de-encrypts an encrypted video signal.

The operation of the known transmitting/receiving system of which a major portion includes the transmitting device 143 and the receiving device 148 will be described. In FIG. 4, the case where a video signal recorded on a DVD disc 118 is displayed on the panel 128 will be described as an example.

First, signal processing is performed to the video signal recorded on the DVD disc 118 by the transmission data processor 116. In this case, the transmission data processor 116 performs processing, such as decoding of a video signal compressed and recorded on the DVD disc 118. HDCP is used for an encryption method of the data encrypter 112.

Next, the video signal transmitted from the transmission data processor 116 is encrypted by the data encrypter 112. Then, the encrypted video signal is transferred to the data transmitter 111. Note that an operation method for encrypting the video signal will be later described.

Subsequently, the data transmitter 111 transmits the encrypted video signal to the high-speed bus 161. In the DVI standard, a signal is transmitted by a method called “TMDS (Transition Minimized Differential Signals). Specifically, the high-speed bus 161 is a serial transmission line, and in the high-speed bus 161, a transmission line for each of red, green and blue channels and a transmission line for clock are provided. The video signal, which has been decomposed into red, green and blue, is transmitted as a baseband signal through the transmission lines. Note that the maximum transfer rate of the high-speed bus 161 is about 750 Mbit/sec or more for each channel. Moreover, in the TMDS method, a differential signal is used, so that resistance against noise and signal distortion is high.

Next, the data receiver 121 receives the encrypted video signal through the high-speed bus 161 and transfers the video signal to the data de-encrypter 122. Subsequently, the encrypted video signal is de-encrypted by the data de-encrypter 122 to be reconstructed into the original video signal. Thereafter, the reconstructed signal is transmitted to the received data processor 126. Note that an operation method used when the video signal is reconstructed will be later described.

Next, after data processing has been performed by the received data processor 126, the content of the video signal is displayed on the panel 128. In this process step, the received data processor 126 performs, for example, gray scale correction and optimization for a signal output to the panel 128 according to a horizontal/vertical scanning cycle.

In the DVI standard, plug-and-play is achieved and a video signal is transmitted according to the resolution of a panel used therein. To achieve plug-and-play, the low-speed bus 162 is provided in the transmission line 160. As the low-speed bus 162, an I2C bus which is called DDC (Display Data Channel) and is a bidirectional bus is used. The I2C bus is a low-speed serial bus with a maximum transmission clock frequency of 100 kHz. The transmission controller 142 obtains the receiving side information 147 through the low-speed bus 162, thereby achieving plug-and-play. The plug-and-play operation will be hereafter described in detail.

The receiving side information 147 is specifically information recorded on a flash memory or an EEPROM and includes information such as the resolution of the panel 128, a frame frequency and the like.

The transmission controller 142 obtains the receiving side information 147 through the low-speed bus 162 and controls the transmission data processor 116 to output a video signal having optimum horizontal and vertical scanning frequencies. Thus, it becomes possible to display an image recorded on the DVD disc 118 on the panel 128 in an optimum state at any time. Note that, for example, a microcomputer (micon) is used as the transmission controller 142.

Another function of the low-speed bus 162 is to perform HDCP authentication. In HDCP, encryption transmission is allowed only after receiving equipment is authenticated as authorized equipment. Information necessary for the authentication is transmitted through the low-speed bus 162. The authentication operation will be hereafter described in detail.

The receiving controller 145 performs an operation in a predetermined manner, based on the second device key 146, using the de-encryption controller 144. An operation result obtained in this manner is transmitted to the transmission controller 142 through the low-speed bus 162. The transmission controller 142 performs an operation in a predetermined manner, based on the first device key 117, using the encryption controller 141. It is confirmed from an obtained operation result and the operation result obtained by the receiving controller 145 that the receiving equipment is not unauthorized equipment. As the receiving controller 145, for example, a micron is used. The transmission controller 142 generates an encryption key, based on the first device key 117, using the encryption controller 141, and the data encrypter 112 performs encryption using the encryption key. In the same manner, the receiving controller 145 generates a de-encryption key, based on the second device key 146, using the de-encryption controller 144, and the data de-encrypter 122 performs de-encryption using the de-encryption key. Note that the first and second device keys 117 and 146 are intrinsic keys of transmission side equipment and receiving side equipment, respectively, and the encryption key generated from the first device key 117 is made to match the de-encryption key generated from the second device key 146 by a process step called “key exchange”.

As has been described, the low-speed bus 162 has two functions, i.e., the function of performing plug-and-play and the function of performing authentication function. Connection methods shown in FIGS. 4 and 5 have been known.

FIG. 4 illustrates the known transmitting/receiving system in the case where the transmission controller 142 includes a port for controlling the low-speed bus 162 and a port for controlling the encryption controller 141.

The port for controlling the low-speed bus 162 is an 12C bus. However, there are cases where the port for controlling the encryption controller 141 is an 12C bus or a parallel bus, thus is not limited to an I2C bus.

FIG. 5 is a block diagram illustrating another example for the known transmitting/receiving system. As shown in FIG. 5, in this example, the case where the transmission controller 142 controls the low-speed bus 162 and the encryption controller 141 with a single port is shown. In this case, the transmission controller 142 can have only a single port. Therefore, a low-price transmission controller can be used, compared to the transmission controller 142 of FIG. 4.

### SUMMARY OF THE INVENTION

With the above-described known transmitting/receiving system, a video signal recorded on a recording medium can be reproduced by a display device. However, rapid progress in AV equipment has been made in recent years, and thus technology for achieving further improvement of display quality, reduction in price and the like has been always required.

As for the known transmitting/receiving system, in the configuration of FIG. 4, not only a port with which the transmission controller 142 controls the low-speed bus 162 but also another port has to be prepared. This increases the size of the transmission controller 142 and also costs are increased.

On the other hand, in the transmitting/receiving system of FIG. 5, two members, i.e., the encryption controller 141 and the third memory for holding the receiving side information 147 are connected to a port of the transmission controller 142. Thus, a load capacity of the port is increased. Accordingly, if the length of the transmission line 160 is increased, a problem arises in which waveform distortion is generated and information can not be transmitted.

Furthermore, in each of the configurations of FIGS. 4 and 5, two members, i.e., the receiving controller 145 and the receiving side information 147 are connected to the low-speed bus 162 in the display device in the receiving side. Thus, a capacity load is large. This also has made difficult to increase the length of the transmission line 160.

It is therefore an object of the present invention to solve the above-described known problems and to provide a transmitting device, a receiving device, and a transmitting/receiving system which allow use of a low-price transmission controller and increase in the length of a transmission line in a simple manner.

To solve the above-described problems, a transmitting device according to the present invention is a transmitting device, connected to a transmission line including a first bus and a second bus at least in an operation state, for encrypting input data and transmitting the data to the first bus, the device including: a transmission side control data memory for storing a plurality of pieces of information to be transmitted from a receiving device through the second bus; a transmission side control data processor for outputting specified information out of the plurality of pieces of information stored in the transmission side control data memory and generating an encryption key based on the information stored in the transmission side control data memory; a data encrypter for encrypting the input data using the encryption key and outputting an encrypted data; and a data transmitter for sending the encrypted data to the first bus.

With this configuration, when the transmitting device is connected to equipment in the receiving side through the transmission line, for example, a plurality of pieces of information necessary for HDCP authentication or plug-and-play can be read out. Thus, without depending on the transfer rate of the second bus, it is possible to execute authentication or plug-and-play. Moreover, a load capacity of the second bus can be reduced, so that, even if the length of the transmission line is increased, waveform distortion is hardly generated.

If the plurality of pieces of information obtained through the second bus include information for equipment which is connected to the transmission line and receives the data, the above-described authentication and plug-and-play can be performed.

If after a reset operation, the transmission side control data memory collectively stores the plurality of pieces of information obtained through the second bus, the plurality of pieces of information are not necessarily obtain through the second bus in a later operation. Therefore, high-speed access to a plurality of pieces of information can be performed.

Moreover, if the data includes a video signal, the transmission controller of the present invention further includes a transmission controller connected to the transmission side control data processor and a transmission data processor connected to a data encrypter, and the transmission controller makes the transmission data processor determine, using the information for the equipment which has been read out from the transmission side control data memory, at least one of a horizontal scanning cycle and a vertical scanning cycle, plug-and-play in displaying the video signal can be specifically realized.

If the first bus is a high-speed bus and the second bus is a low-speed bus with a lower transfer rate than that of the first bus, fabrication costs can be reduced, compared to the case where a high-speed bus is used for the second bus. In the transmitting device of the present invention, a load capacity of the second bus is lower than that in the known transmitting device. Thus, even if a low-price bus is used, waveform distortion of a signal is hardly generated.

The transmission side control data memory, the transmission side control data processor, the data encrypter, and the data transmitter may be provided in a single LSI, and in the LSI, a terminal for connecting the transmission side control data processor and the second bus may be provided.

A receiving device according to the present invention is a receiving device, connected to a transmission line including a first bus and a second bus at least in an operation state, for receiving encrypted data through the first bus, the device including: a data receiver for receiving the encrypted data through the first bus; a receiving side control data memory for storing a plurality of pieces of information; a receiving side control data processor for outputting the plurality of pieces of information stored in the receiving side control data memory to the second bus and generating a de-encryption key based on the information from the second bus and the information stored in the receiving side control data memory; and a data de-encrypter for de-encrypting the encrypted data using the de-encryption key and outputting de-encrypted data.

With this configuration, a branch of the second bus can be eliminated, so that a load capacity per the second bus can be reduced, compared to the known receiving device. Thus, even if the length of the transmission line is increased, waveform distortion is hardly generated and also the length of the transmission line can be increased in a simple manner.

If the encrypted data includes a video signal, the data de-encrypter is connected to a received data processor connected to a panel capable of displaying a content of the de-encrypted data at least in an operation state; and the plurality of pieces of information stored in the receiving side control data memory include information for data processible by the panel, an authorized copy of the video signal can be deterred and plug-and-play can be realized when the receiving device is combined with a transmitting device.

The receiving device may further includes: a memory in which the plurality of pieces of information are held; a receiving controller for transmitting the plurality of pieces of information from the memory to the receiving side control data processor; a received data processor for processing the de-encrypted data based on the plurality of pieces of information; and a panel for displaying data processed by the received data processor, and the encrypted data may include a video signal, and the plurality of pieces of information may include information for data processible by the panel.

It is preferable that after a reset operation, the receiving side control data memory collectively stores the plurality of pieces of information. Thus, a transfer rate does not depend on access speed of the second bus.

If the first bus is a high-speed bus and the second bus is a low-speed bus with a lower transfer rate than that of the first bus, a receiving device which allows suppression of waveform distortion of a signal in the second bus can be obtained.

The data receiver, the receiving side control data memory, the receiving side control data processor, and the data de-encrypter may be provided in a signal LSI and in the LSI, a terminal for connecting the receiving side control data processor and the second bus may be provided.

A transmitting/receiving system according to the present invention is a transmitting/receiving system which includes a transmitting device for obtaining encrypted data from input data and transmitting the encrypted data, a receiving device for receiving the encrypted data and de-encrypting the received data, and a transmission line including a first bus and a second bus and connecting between the transmitting device and the receiving device. In the system, the transmitting device includes a transmission side control data memory for storing a plurality of pieces of information to be transmitted from a receiving device through the second bus, a transmission side control data processor for outputting specified information out of the plurality of pieces of information stored in the transmission side control data memory and generating an encryption key based on the information stored in the transmission side control data memory, a data encrypter for encrypting the input data using the encryption key and outputting an encrypted data, and a data transmitter for sending the encrypted data to the first bus, and the receiving device includes a data receiver for receiving the encrypted data through the first bus, a receiving side control data memory for storing the plurality of pieces of information, a receiving side control data processor for outputting the plurality of pieces of information stored in the receiving side control data memory to the second bus and generating a de-encryption key based on the information transmitted from the transmission control data processor through the second bus and the information stored in the receiving side control data memory, and a data de-encrypter for de-encrypting the encrypted data using the de-encryption key and outputting de-encrypted data.

With this system, a load capacity of the second bus can be reduced, compared to the case where the transmitting device of the present invention is combined with a known receiving device. Therefore, the generation of wave distortion of a signal to be transmitted can be suppressed and further increase in the length of the transmission line can be realized.

If the encrypted data includes a video signal, the data de-encrypter is connected to the received data processor connected to a panel capable of displaying a content of the de-encrypted data at least in an operation state, and the plurality of pieces of information stored in the receiving side control data memory include information for data processible by the panel, a video signal can be displayed.

The encrypted data may include a video signal, the receiving device may further include a memory in which the plurality of pieces of information are held, a receiving controller for transmitting the plurality of pieces of information from the memory to the receiving side control data processor, a received data processor for processing the de-encrypted data based on the plurality of pieces of information, and a panel for displaying data processed by the received data processor, and the plurality of pieces of information may include information for data processible by the panel.

If after a reset operation, the receiving side control data memory collectively stores the plurality of pieces of information, and the transmission side control data memory collectively stores the plurality of pieces of information transmitted from the receiving side control data memory through the second bus, exchange of a plurality pieces of information through the second bus in an operation state can be suppressed. Therefore, when a transmission rate of the second bus is relatively low, authentication and plug-and-play can be rapidly performed.

It is preferable that the transmitting device further includes a transmission controller connected to the transmission side control data processor and a transmission data processor connected to the data encrypter, and the transmission controller makes the transmission data processor determine, using the information for the panel which has been read out from the transmission side control data memory, at least one of a horizontal scanning cycle and a vertical scanning cycle of the video signal. Thus, optimum data can be transmitted to the panel.

It is preferable that the first bus is a high-speed bush and the second bus is a low-speed bus with a lower transfer rate than that of the first bus.

The transmission side control data memory, the transmission side control data processor, the data encrypter, and the data transmitter may be all provided in a first LSI, and in the first LSI, a terminal for connecting the transmission side control data processor and the second bus may be provided.

The data receiver, the receiving side data control memory, the receiving side control data processor, and the data de-encrypter may be all provided in a second LSI, and in the second LSI, a terminal for connecting the receiving side control data processor and the second bus may be provided.

### BRIEF DESCRIPTION OF THE DRAWINGS

FIG. 1 is a block diagram illustrating a transmitting device according to a first embodiment of the present invention.

FIG. 2 is a block diagram illustrating a receiving device according to a second embodiment of the present invention.

FIG. 3 is a block diagram illustrating a transmitting/receiving system according to a third embodiment of the present invention.

FIG. 4 is a block diagram illustrating a first configuration example for a known transmitting/receiving system.

FIG. 5 is a block diagram illustrating a second configuration example for the known transmitting/receiving system.

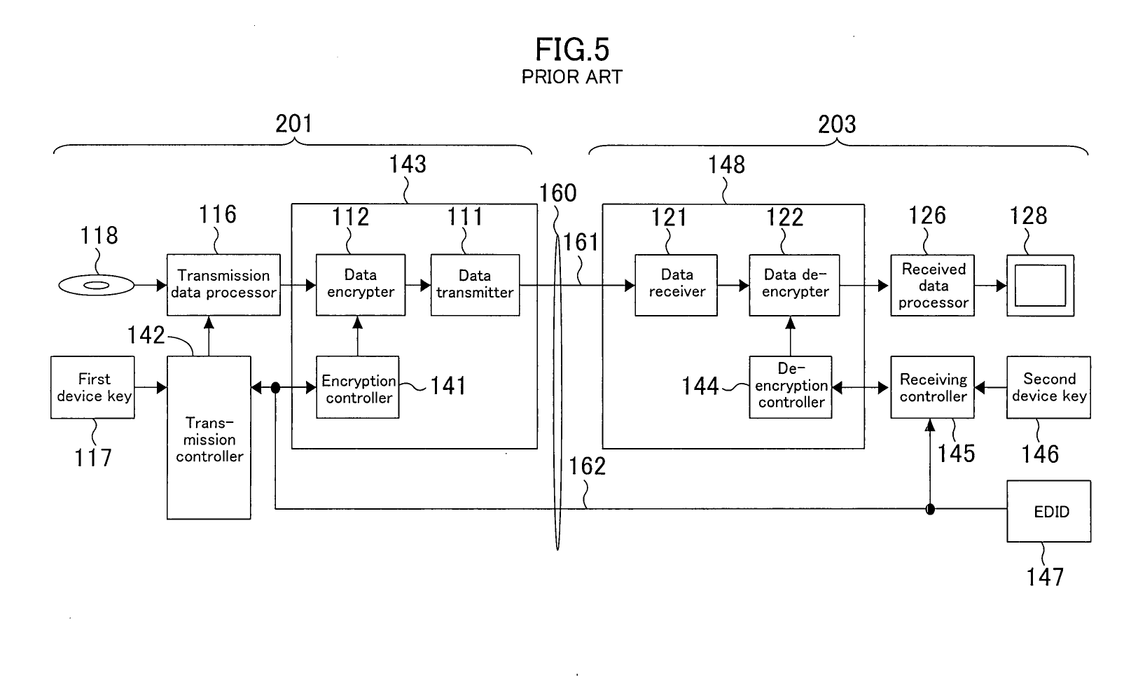

### DESCRIPTION OF THE PREFERRED EMBODIMENTS

Hereafter, embodiments of the present invention will be described with reference to the accompanying drawings.

### First Embodiment

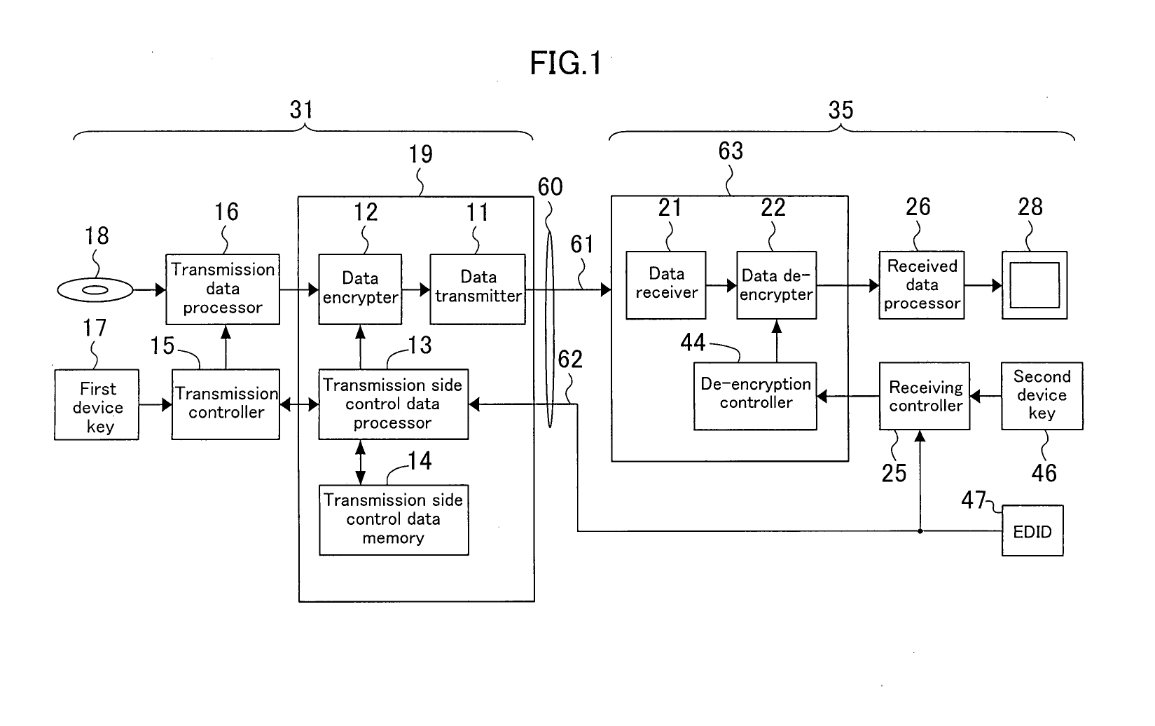

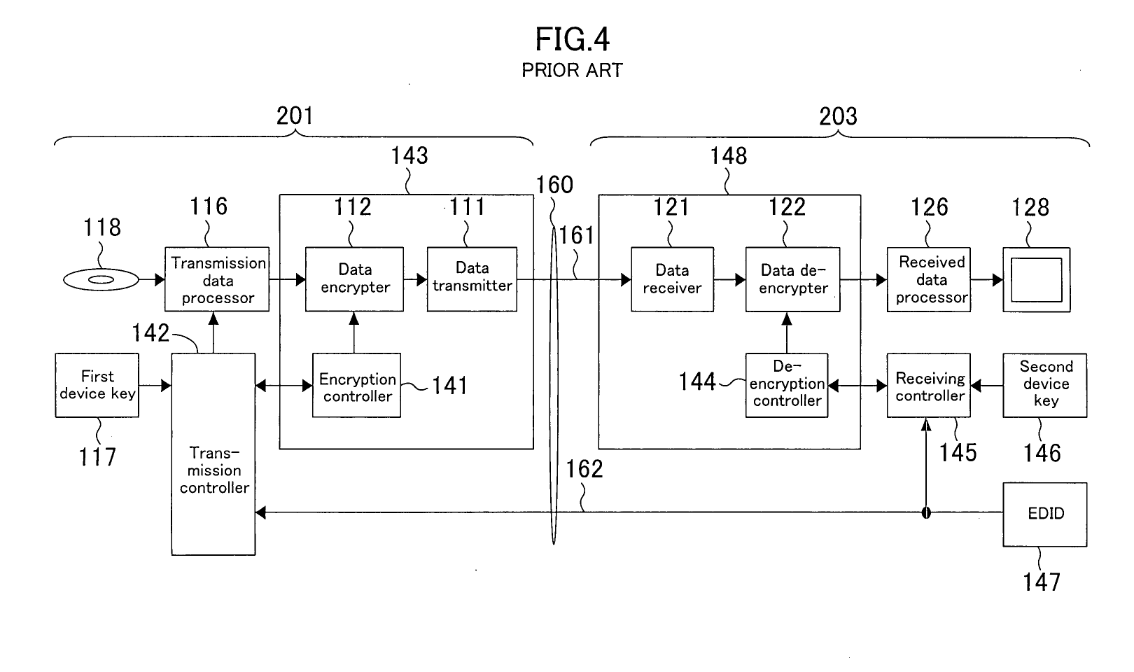

FIG. 1 is a block diagram illustrating a transmitting device according to a first embodiment of the present invention. In FIG. 1, a display device 35 connected to a transmitting device 19 is shown to make it easy to describe the device. The display device has the same configuration as that of FIG. 4.

As shown in FIG. 1, the transmitting device 19 of this embodiment is characterized by including transmission side control data memory 14 for storing EDID 47 of the display device 35 and a transmission side control data processor 13.

The transmitting device 19 of this embodiment is part of a transmission side processing device 31 such as a DVD player. Specifically, the transmission side processing device 31 includes a first memory for holding a first device key, a transmission controller 15 connected to the first memory, a transmission data processor 16, and a transmitting device 19.

The transmitting device 19 includes the transmission side control data memory 14, the transmission side control data processor 13 connected to each of the transmission controller 15 and the transmission side control data memory 14, a data encrypter 12 connected to the transmission data processor 16, and a data transmitter 11 connected to the data encrypter 12. In many cases, the transmitting device 19 is provided as a signal LSI. Note that each member of the transmitting device 19 may be hardware and also may have a function that can be realized by a program executed by a CPU. In appearance, the transmitting device 19 of this embodiment differs from the known transmitting device in that a terminal for connecting the transmission side control data processor 13 to a low-speed bus 62 of the transmission line 60 is provided.

Moreover, the display device 35 of FIG. 1 has the same structure as that of the known display device and includes a receiving device 63, a second memory for holding a second device key 46, a third memory for holding the EDID 47, a receiving controller 25, a received data processor 26, and a panel 28. The third memory is connected to the transmission side control data processor 13 through the low-speed bus 62 of the transmission line 60. In this case, the low-speed bus 62 is, for example, an I2C bus, which is a low-speed serial bus with a maximum transmission clock frequency of 100 kHz.

The video signal transmitting operation using the above-described transmitting device 19 will be described. In the embodiment of FIG. 1, a video signal recorded on a DVD disc 18 is transmitted to a display device such as a liquid crystal display device. Here, the case where the transmission line 60 is based on the DVI standard and the data encrypter 12 performs encryption based on the HDCP standard will be described.

First, signal processing is performed to a video signal recorded on the DVD disc 18 by the transmission data processor 16. In this case, the transmission data processor 16 performs processing, such as decoding of a video signal compressed and recorded on the DVD disc 18. As an encryption method of the data encrypter 12, HDCP is used.

Next, the video signal transmitted from the transmission data processor 16 is encrypted by the data encrypter 12. Then, the encrypted video signal is transferred to the data transmitter 11. Note that an operation method for encrypting the video signal will be later described.

Subsequently, the data transmitter 11 transmits the encrypted video signal to the high-speed bus 61. In the high-speed bus 61, the video signal is transmitted by the TMDS method. Specifically, the high-speed bus 61 is a serial transmission line, and in the high-speed bus 61, a transmission line for each of red, green and blue channels and a transmission line for a clock are provided. The video signal, which has been decomposed into red, green and blue, is transmitted as a baseband signal through the transmission lines. Note that the maximum transfer rate of the high-speed bus 61 is about 750 Mbit/sec or more for each channel. Moreover, in the TMDS method, a differential signal is used.

Next, the plug-and-play operation in the case where the transmitting device of this embodiment is used will be described.

First, the transmission side control data memory 14 stores information for the display device 35 such as resolution and a frame cycle, and more specifically, the EDID 47 of the display device 35. SRAM, DRAM and like memories are examples for the transmission side control data memory 14. In this process step, the transmission side control data processor 13 reads out the EDID 47 through the low-speed bus 62 of the transmission line 60 and writes the EDID 47 on the transmission side control data memory 14. This operation may be performed at any time and may be collectively performed immediately after a reset. However, if the operation of storing the EDID 47 is performed only once immediately after a reset, it is not necessary to use the low-speed bus 62 later, thus allowing high-speed operation.

Next, the transmission controller 15 reads out the EDID 47 stored in the transmission side control data memory 14 and controls the transmission data processor 16 to adjust a setting of the display device 35 so that resolution, a frame frequency and the like are optimized. In other words, in this process step, the horizontal scanning cycle and vertical scanning cycle of the video signal are optimized.

Next, HDCP authentication in the transmitting device 19 of this embodiment will be briefly described. In HDCP, encryption transmission is allowed only after receiving equipment is authenticated as authorized equipment.

First, the transmission side control data processor 13 reads out information (authentication information) necessary for HDCP authentication from the second memory in the display device 35 and writes the authentication information on the transmission side control data memory 14. In this case, the “information necessary for authentication” is not only device key information but also information about whether equipment is in a state where authentication can be executed, version information for HDCP and the like. In this process step, the information necessary for authentication is transmitted through the low-speed bus 62 of the transmission line 60. In the transmitting device 19 of this embodiment, the transmission side control data memory 14 may be formed of a single memory so that the EDID and the information necessary for authentication are stored in a different address and may be formed of memories each of which separately store different data. However, if the transmission side control data memory 14 is formed of a single memory, the usage efficiency of a memory becomes high and fabrication costs can be reduced. In this case, it is preferable that the memory has a capacity of at least 512 Byte or more.

Next, it is confirmed, based on an operation result for the transmission side control data processor 13 and an operation result for a de-encryption controller, which has been transmitted to the transmission controller 15 through the low-speed bus 62, that the display device 33 (or the receiving device 63) is not unauthorized equipment, when HDCP authentication is performed. Note that when an operation is performed in the transmitting device side, the transmission controller 15 performs an operation, based on the first device key 17, using the transmission side control data processor 13.

Next, when it is determined that the display device 35 is not unauthorized equipment, the transmission controller 15 makes the transmission side control data processor 13 generate an encryption key. Note that the transmission controller 15 used in this embodiment is, for example, a microcomputer (micon) and controls the transmitting device 19.

As has been described, with the transmitting device 19 of this embodiment, the transmission controller 15 can control the transmitting device 19 with a single port, so that a system can be formed of, for example, a low-price micon. Moreover, if the configuration is made so that the EDID 47 of the display device 35 is stored in the transmission side control data memory 14 only once after a reset, the transmission controller 15 only has to access the transmission side control data memory 14 in a later operation state. A data transfer rate between the transmission side control data memory 14 and the transmission controller 15 is higher than a transfer rate at the low-speed bus 62. Therefore, with the transmitting device of this embodiment, plug-and-play and authentication of equipment can be performed without depending on the access speed of the low-speed bus 62. For example, even when the transmission controller 15 and the transmitting device 19 are connected by a higher speed parallel bus than the low-speed bus 62, an access waiting time is not generated and a high-speed access can be achieved.

Furthermore, a one-to-one connection is made by the low-speed bus 62 between the transmitting device 19 and the receiving device 63. Thus, a load capacity can be reduced. Therefore, even if the length of the transmission line 60 is increased, waveform distortion is hardly generated and the length of the transmission line 60 can be increased in a simple manner.

Note that in the configuration of FIG. 1, the transmission controller 15 accesses the first device key 17. However, even if a configuration in which the transmitting device 19 accesses the first device key 17 is used, the same effects can be obtained.

In this embodiment, the case where a transmission line is based on the DVI standard has been described. However, it is needless to say that the transmission line is not limited to the DVI standard, as long as the transmitting device includes the transmission line has the same function and performance as that in the above-described embodiment. For example, the transmission line may be a transmission line through which a signal obtained by combining a DVI standard signal with a sound signal is transmitted. As for such a standard, HDMI (High-definition Multimedia Interface) has been known. The maximum length of a bus is 5 m in the DVI standard and about 10 m in the HDMI standard. Therefore, the transmitting device of this embodiment which can suppress waveform distortion is suitable for the HDIM standard. In the HDMI standard, not only a video signal but also a sound signal can be transmitted.

Note that in FIG. 1, the example in which a video signal recorded on a DVD has been described. A recording medium is not limited to a DVD but may be a hard disc of a computer. Moreover, the transmission side processing device 31 may be a set-top box (STB).

Note that in the description made in this embodiment, the transmitting device 19 is part of the transmission side processing device 31. However, there may be cases where the entire transmission side device 31 is called a “transmitting device” in a broad sense.

### Second Embodiment

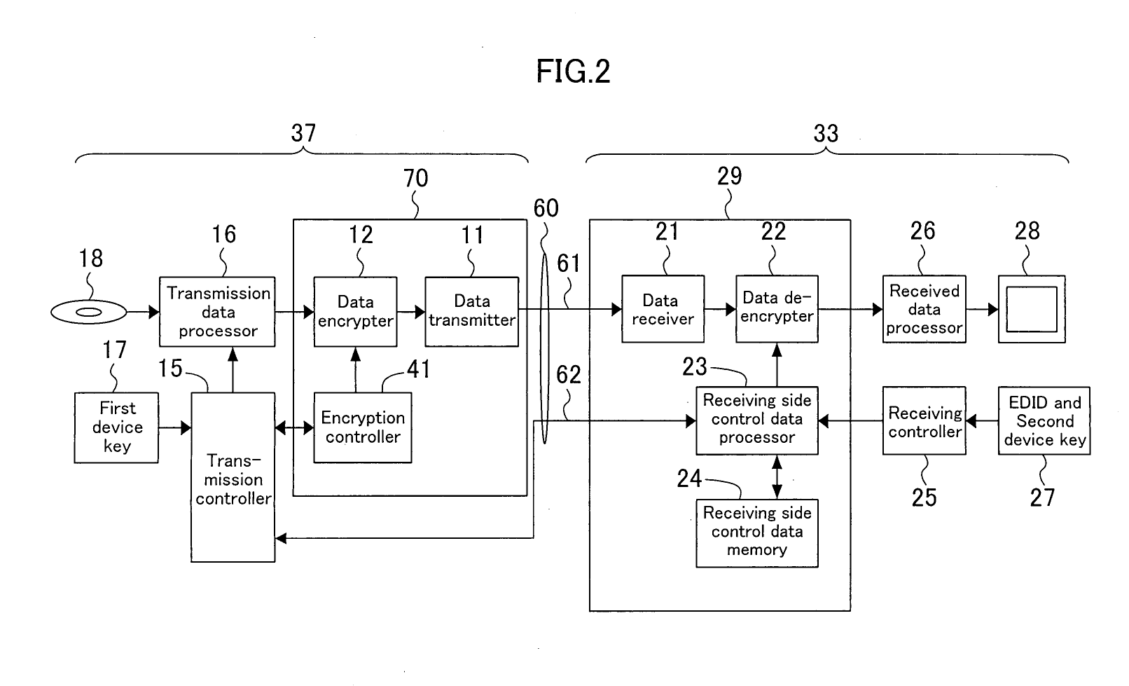

FIG. 2 is a block diagram illustrating a receiving device according to a second embodiment of the present invention. In FIG. 2, a transmission side processing device 37 having the same configuration as that of the known transmission side processing device is shown to make it easy to describe the device.

As shown in FIG. 2, a receiving device 29 according to the second embodiment is, for example, part of the display device 33 and is characterized by including a receiving side control data memory 24 for storing the EDID and information necessary for authentication of equipment and a receiving side control data processor 23.

The display device 33 of FIG. 2 includes a receiving device 29 connected to a transmission line 60 including a high-speed bus 61 and a low-speed bus 62, a fourth memory for holding receiving side information 27 including the EDID and a second device key, a receiving controller 25 for controlling the authentication operation of the receiving device 29, a received data processor 26 for receiving a signal output from the receiving device 29, and a panel 28 connected to the received data processor 26.

The receiving device 29 includes a data receiver 21 for receiving an encrypted video signal through the high-speed bus 61, a receiving side control data memory 24, a receiving side control data processor 23 connected to the receiving side control data memory 24 and also to the low-speed bus 62, and a data de-encrypter 22 which is connected to the data receiver 21 and de-encrypts the encrypted video signal. Note that in the example of FIG. 2, unlike FIG. 1, the receiving side information 27 is held by a flush memory or an EEPROM and includes both of the EDID and the second device key. Moreover, in appearance, the receiving device 29 of this embodiment differs from the known receiving device in that a terminal for connecting the receiving side control data processor 23 to the low-speed bus 62 of the transmission line 60 is provided.

Moreover, the transmission side processor 37 of FIG. 2 has the same configuration as that of the known transmission side processor and includes a fifth memory for holding a first device key, a transmission controller 15, a transmission data processor 16, and transmitting device 70.

The transmitting device 70 includes a transmission data processor 16 for encrypting a video signal recorded on a DVD disc 18, an encryption controller 41 connected to the receiving side control data processor 23 through the low-speed bus 62 and controlled by the transmission controller 15, and a data transmitter 11 for transmitting the encrypted video signal to the data receiver 21 through the high-speed bus 61.

Next, the video signal receiving operation of the receiving device 29 of this embodiment will be described. In this embodiment, the case where the transmission line 60 is based on the DVI standard and the data de-encrypter 22 performs de-encryption based on the HDCP standard will be described as an example.

First, the data receiver 21 receives a video signal which has been transmitted from the data transmitter 11 through the high-speed bus 61 and has been encrypted. The video signal is transmitted by the TMDS method. In the high-speed bus 61, a transmission line for each of red, green and blue channels and a transmission line for a clock are provided. The video signal, which has been decomposed into red, green and blue, is transmitted as a baseband signal through the transmission lines. Note that a maximum transfer rate of the high-speed bus 61 is about 750 Mbit/sec or more for each channel.

Subsequently, the encrypted video data is de-encrypted by the data de-encrypter 22 to be reconstructed into the original video signal. Thereafter, the reconstructed signal is transmitted to the received data processor 26. Next, after the signal processing has been performed by the received data processor 26, a content of the video signal is displayed by the panel 28. In this case, the received data processor 26 performs, for example, gray scale correction and optimization of a signal output to the panel 28 according to the horizontal/vertical scanning cycle.

Next, plug-and-play and authentication of equipment in the receiving device of this embodiment will be briefly described.

The receiving side control data memory 24 stores information, such as resolution and a frame cycle, for the panel 28 and more specifically, the EDID. SRAM, DRAM and like memories are examples for the receiving side control data memory 24. The receiving side control data processor 23 receives the EDID from the receiving controller 25 and writes the EDID on the receiving side control data memory 24. This operation may be performed at any time and may be collectively performed immediately after a reset. However, if the operation of storing the EDID is performed, only once immediately after a reset an access to the receiving side information 27 by the receiving controller 25 can be omitted. Therefore, it is more advantageous to store the EDID only once immediately after a reset.

The transmission controller 15 obtains the EDID and controls the transmission data processor 16 to output a video signal having optimum horizontal and vertical scanning frequencies for the panel 28. Thus, it becomes possible to display an image recorded on the DVD disc 18 on the panel 28 in an optimum state at any time.

Moreover, the receiving control data processor 23 receives information necessary for HDCP authentication from the receiving controller 25 and writes the information on the receiving side control data memory 24. In this case, the “information necessary for HDCP authentication” includes not only a device key but also information about whether equipment is in a state where authentication can be executed, version information for HDCP and the like.

The receiving side control data memory 24 may be formed of a single memory so that the EDID and the information necessary for authentication are stored in a different address and may be formed of memories each of which separately stores the EDID or the information necessary for authentication. However, if the receiving side control data memory 24 is formed of a single memory, the usage efficiency of a memory becomes high and fabrication costs can be reduced. In this case, it is necessary that the capacity of the memory is at least 512 Byte or more.

Moreover, the receiving controller 25 is, for example, a micon, and controls the receiving device 29.

Specifically, the receiving controller 25 performs an operation in a predetermined manner, based on the second device key, using the receiving side control data processor 23. An operation result obtained in this manner is transmitted to the transmission controller 15 through the low-speed bus 62 and the encryption controller 41. The transmission controller 15 performs an operation in a predetermined manner, based on the first device key 17, using the encryption controller 41 and confirms from an obtained operation result and the operation result by the receiving controller 25 that the receiving equipment is not unauthorized equipment.

When it is confirmed that the receiving device is not unauthorized equipment, using the second device key of the receiving side information 27, the receiving side control data processor 23 is controlled to generate a de-encryption key. Moreover, the receiving side control data processor 23 reads out, in response to a request of the transmission side processing device 37, information stored in the receiving side control data memory 24 and transmits the information to the data receiver 21. Thus, the video signal which the received data processor 26 can process can be transmitted, so that plug-and-play is realized.

As has been described, when the receiving device 29 of this embodiment is used for a transmitting/receiving system, a one-to-one connection is made by the low-speed bus 62 between the receiving device 70 and the transmitting device 29. Thus, a load capacity per the low-speed bus 62 can be reduced. Therefore, even if the length of the transmission line 60 is increased, waveform distortion is hardly generated and the length of the transmission line 60 can be increased in a simple manner.

Note that if the configuration is made so that the receiving information 27 is stored in the receiving side control data memory 24 only once after a reset, the operation speed does not depend on the access speed of the low-speed bus 62. For example, even when the receiving controller 25 and the transmitting device 29 to each other are connected through a higher speed parallel bus than the low-speed bus 62, an access waiting time is not generated and a high-speed access can be achieved.

Furthermore, in the configuration of FIG. 2, the receiving controller 25 accesses the receiving side information 27. However, even if a configuration in which the receiving device 29 accesses the receiving side information 27 is used, the same effects can be obtained. Moreover, in the configuration of FIG. 2, the EDID and the device key are held in the receiving side information 27. However, the EDID and the device key may be held separately and a configuration in which the receiving controller 25 accesses one of the EDID and the device key and the receiving device 29 accesses the other may be used.

In the description of this embodiment, the case where the transmission line is based on the DVI standard has been described. However, it is needless to say that a standard is not limited to the DVI standard, as long as the receiving device includes a transmission line similar to that of this embodiment. For example, a transmission line through which a signal obtained by combining a DVI standard signal with a sound signal is transmitted may be used.

Note that as the display device 33, a liquid crystal display device, a TV set, a CRT and other various kinds of devices can be used.

Moreover, in the description of this embodiment, the receiving device 29 is part of the display device 33. However, there may be cases where the entire display device 33 is called a “receiving device” in a broad sense.

### Third Embodiment

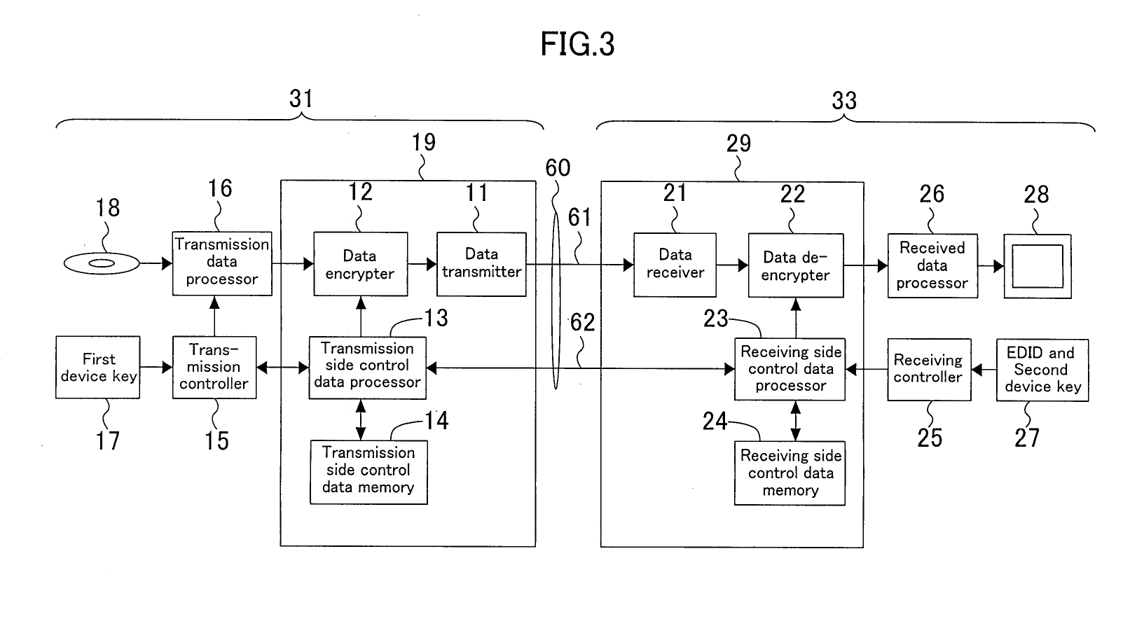

FIG. 3 is a block diagram illustrating a transmitting/receiving system according to a third embodiment of the present invention. As shown in FIG. 3, the transmitting/receiving system of this embodiment is a combination of the transmitting device 19 of the first embodiment shown in FIG. 1 and the receiving device 29 of the second embodiment shown in FIG. 2. In FIG. 3, each member also shown in FIGS. 1 and 2 is identified by the same reference numeral. Moreover, description of each member of which the operation has been already described will be omitted. Moreover, in this embodiment, the case where the transmission line 60 is based on the DVI standard and the data encrypter 12 and the data de-encrypter 22 performs encryption and de-encryption based on the HDCP standard, respectively, will be described as an example.

In the display device 33, the receiving controller 25 reads out the receiving side information 27 and makes the receiving side control data memory 24 store the information. In this case, the receiving side information 27 includes the EDID and the second device key.

The transmission side control data processor 13 reads out the receiving side information 27 stored in the receiving side control data memory 24 through the low-speed bus 62 and makes the transmission side control data memory 14 store the information.

The transmission controller 15 performs a control operation so that the transmission data processor 16 adjusts settings, based on the receiving side information stored in the transmission side control data memory 14, to achieve horizontal and vertical scanning cycles and the like suitable for the panel 28. Meanwhile, the transmission controller 15 makes the transmission side control data processor 13 generate an encryption key and realizes plug-and-play.

As has been described, in the transmitting/receiving system of this embodiment, the transmission controller 15 can control the transmitting device 19 with a single port, so that an area and fabrication costs can be reduced. Moreover, fabrication costs can be reduced by forming the transmission controller 15 of a low-price micon.

Moreover, if the EDID, the second device key and the like in the receiving side information 27 is stored in the transmission side control data memory 14 only once after a reset, the transmission controller 15 only has to access to the transmission side control data memory 14 when the transmission controller 15 uses the EDID and the second device key. Specifically, it is no linger necessary to access the low-speed bus 62 every time when authentication or encryption is performed, so that the operation speed does not depend on the access speed of the low-speed bus 26. For example, even when the transmission controller 15 and the transmitting device 19 are connected to each other through a higher speed parallel bus than the low-speed bus 62, an access waiting time is not generated and a high-speed access can be achieved. Furthermore, in this embodiment, a one-to-one connection is made by the low-speed bus 62 between the transmitting device 19 and the receiving device 63. Thus, the load capacity of the low-speed bus 62 can be reduced. Therefore, even if the length of the transmission line 60 is increased, waveform distortion is hardly generated and the length of the transmission line 60 can be increased in a simple manner.

As has been described, in the transmitting/receiving system of this embodiment, even compared to the first and second embodiments, costs for fabricating a system can be further reduced and signal transmission performance can be improved.

Note that in the configuration of FIG. 3, the transmission controller 15 accesses the first device key 17. However, even if a configuration in which the transmitting device 19 accesses the first device key 17 is used, the same effects can be obtained.

In the same manner, in the configuration of FIG. 3, the receiving controller 25 accesses the receiving side information 27. However, even if a configuration in which the receiving device 29 accesses the receiving side information 27 is used, the same effects can be obtained. Moreover, in the configuration of FIG. 3, the EDID and the device key are held in the receiving side information 27. However, the EDID and the device key may be held separately. In that case, a configuration in which the receiving controller 25 accesses one of the EDID and the device key, and the receiving device 29 accesses the other may be used.

Note that in this embodiment, the transmitting/receiving system in the case where the transmission line 60 is based on the DVI standard has been described. However, it is needless to say that a transmission line other than the DVI standard transmission line can be used, as long as a transmission line having similar performance as that of the DVI standard transmission line. For example, a transmission line, such as a transmission line based on the HDMI standard through which a signal obtained by combining a DVI standard signal with a sound signal is transmitted may be used.

Note that in the transmission line 60, the low-speed bus 62 may be replaced by a bus having an equivalent transfer rate to that of the high-speed bus 61. However, in terms of costs, the configuration of this embodiment is more advantageous.

1. A transmitting device, connected to a transmission line including a first bus and a second bus at least in an operation state, for encrypting input data and transmitting the data to the first bus, the device comprising:
a transmission side control data memory for storing a plurality of pieces of information to be transmitted from a receiving device through the second bus;
a transmission side control data processor for outputting specified information out of the plurality of pieces of information stored in the transmission side control data memory and generating an encryption key based on the information stored in the transmission side control data memory;
a data encrypter for encrypting the input data using the encryption key and outputting an encrypted data; and
a data transmitter for sending the encrypted data to the first bus.

2. The transmitting device of claim 1, wherein the plurality of pieces of information obtained through the second bus include information for equipment which is connected to the transmission line and receives the encrypted data.

3. The transmitting device of claim 1, wherein after a reset operation, the transmission side control data memory collectively stores the plurality of pieces of information obtained through the second bus.

4. The transmitting device of claim 2,
wherein the data includes a video signal,
wherein the transmission controller further includes a transmission controller connected to the transmission side control data processor and a transmission data processor connected to a data encrypter, and
wherein the transmission controller makes the transmission data processor determine, using the information for the equipment which has been read out from the transmission side control data memory, at least one of a horizontal scanning cycle and a vertical scanning cycle.

5. The transmitting device of claim 1, wherein the first bus is a high-speed bus and the second bus is a low-speed bus with a lower transfer rate than that of the first bus.

6. The transmitting device of claim 1, wherein the transmission line is based on the DVI standard or the HDMI standard.

7. The transmitting device of claim 1,
wherein the transmission side control data memory, the transmission side control data processor, the data encrypter, and the data transmitter are provided in a single LSI, and
wherein in the LSI, a terminal for connecting the transmission side control data processor and the second bus is provided.

8. A receiving device, connected to a transmission line including a first bus and a second bus at least in an operation state, for receiving encrypted data through the first bus, the device comprising:
a data receiver for receiving the encrypted data through the first bus;
a receiving side control data memory for storing a plurality of pieces of information;
a receiving side control data processor for outputting the plurality of pieces of information stored in the receiving side control data memory to the second bus and generating a de-encryption key based on the information from the second bus and the information stored in the receiving side control data memory; and
a data de-encrypter for de-encrypting the encrypted data using the de-encryption key and outputting de-encrypted data.

9. The receiving device of claim 8,
wherein the encrypted data includes a video signal, wherein the data de-encrypter is connected to a received data processor connected to a panel capable of displaying a content of the de-encrypted data at least in an operation state, and
wherein the plurality of pieces of information stored in the receiving side control data memory include information for data processible by the panel.

10. The receiving device of claim 8, further comprising:
a memory in which the plurality of pieces of information are held;
a receiving controller for transmitting the plurality of pieces of information from the memory to the receiving side control data processor;
a received data processor for processing the de-encrypted data based on the plurality of pieces of information; and
a panel for displaying data processed by the received data processor, wherein the encrypted data includes a video signal, and wherein the plurality of pieces of information include information for data processible by the panel.

11. The receiving device of claim 8, wherein after a reset operation, the receiving side control data memory collectively stores the plurality of pieces of information.

12. The receiving device of claim 8, wherein the first bus is a high-speed bus and the second bus is a low-speed bus with a lower transfer rate than that of the first bus.

13. The receiving device of claim 8, wherein the transmission line is based on the DVI standard or the HDMI standard.

14. The receiving device of claim 8,
wherein the data receiver, the receiving side control data memory, the receiving side control data processor, and the data de-encrypter are provided in a single LSI, and
wherein in the LSI, a terminal for connecting the receiving side control data processor and the second bus.

15. A transmitting/receiving system which includes a transmitting device for obtaining encrypted data from input data and transmitting the encrypted data, a receiving device for receiving the encrypted data and de-encrypting the received data, and a transmission line including a first bus and a second bus and connecting between the transmitting device and the receiving device,
wherein the transmitting device includes
a transmission side control data memory for storing a plurality of pieces of information to be transmitted from a receiving device through the second bus,
a transmission side control data processor for outputting specified information out of the plurality of pieces of information stored in the transmission side control data memory and generating an encryption key based on the information stored in the transmission side control data memory,
a data encrypter for encrypting the input data using the encryption key and outputting an encrypted data, and
a data transmitter for sending the encrypted data to the first bus, and
wherein the receiving device includes
a data receiver for receiving the encrypted data through the first bus,
a receiving side control data memory for storing the plurality of pieces of information,
a receiving side control data processor for outputting the plurality of pieces of information stored in the receiving side control data memory to the second bus and generating a de-encryption key based on the information transmitted from the transmission control data processor through the second bus and the information stored in the receiving side control data memory, and
a data de-encrypter for de-encrypting the encrypted data using the de-encryption key and outputting de-encrypted data.

16. The transmitting/receiving system of claim 15,
wherein the encrypted data includes a video signal,
wherein the data de-encrypter is connected to the received data processor connected to a panel capable of displaying a content of the de-encrypted data at least in an operation state, and
wherein the plurality of pieces of information stored in the receiving side control data memory include information for data processible by the panel.

17. The transmitting/receiving system of claim 15,
wherein the encrypted data includes a video signal,
wherein the receiving device further includes a memory in which the plurality of pieces of information are held, a receiving controller for transmitting the plurality of pieces of information from the memory to the receiving side control data processor, a received data processor for processing the de-encrypted data based on the plurality of pieces of information, and a panel for displaying data processed by the received data processor, and
wherein the plurality of pieces of information include information for data processible by the panel.

18. The transmitting/receiving system of claim 15, wherein after a reset operation, the receiving side control data memory collectively stores the plurality of pieces of information, and
wherein the transmission side control data memory collectively stores the plurality of pieces of information transmitted from the receiving side control data memory through the second bus.

19. The transmitting/receiving system of claim 16,
wherein the transmitting device further includes a transmission controller connected to the transmission side control data processor and a transmission data processor connected to the data encrypter, and
wherein the transmission controller makes the transmission data processor determine, using the information for the panel which has been read out from the transmission side control data memory, at least one of a horizontal scanning cycle and a vertical scanning cycle of the video signal.

20. The transmitting/receiving system of claim 15, wherein the first bus is a high-speed bus and the second bus is a low-speed bus with a lower transfer rate than that of the first bus.

21. The transmitting/receiving system of claim 15, wherein the transmission line is based on the DVI standard or the HDMI standard.

22. The transmitting/receiving system of claim 15,
wherein the transmission side control data memory, the transmission side control data processor, the data encrypter, and the data transmitter are all provided in a first LSI, and
wherein in the first LSI, a terminal for connecting the transmission side control data processor and the second bus is provided.

23. The transmitting/receiving system of claim 15,
wherein the data receiver, the receiving side control data memory, the receiving side control data processor, and the data de-encrypter are all provided in a second LSI, and
wherein in the second LSI, a terminal for connecting the receiving side control data processor and the second bus is provided.
